(19) United States
(12) Patent Application Publication
(10) Pub. No.: US 2011/0156982 A1
(43) Pub. Date: Jun. 30, 2011

(54) SCREW FOR USE IN A RADIO WAVE RECEIVER, METHOD OF MAKING THE SCREW, AND RADIO WAVE RECEIVER USING THE SCREW

(75) Inventors: Ken ASADA, Izumi-shi (JP); Takayuki Furujyo, Izumi-shi (JP); Yoshihiro Maruyama, Hamura-shi (JP); Junichi Sato, Hino-shi (JP)

(73) Assignees: NEOMAX MATERIALS CO., Ltd., Osaka (JP); CASIO COMPUTER CO., LTD., Tokyo (JP)

(21) Appl. No.: 12/974,003

(22) Filed: Dec. 21, 2010

(30) Foreign Application Priority Data
Dec. 24, 2009 (JP) 2009-292911

(51) Int. Cl. H01Q 1/42; F16B 23/00

(52) U.S. Cl. 343/872; 411/403

(57) ABSTRACT

A screw for use in a radio wave receiver includes a metal screw body that includes a shank and a head, and an insulation resin layer formed on at least a back of the screw head. In the radio wave receiver, a back cover and a case are secured together firmly by a threaded engagement of a threaded part of the shank, on which no insulation resin layer is formed, with a screw hole formed in the case while the insulation resin layer is disposed therebetween.

### CROSS-REFERENCE TO RELATED APPLICATIONS

This application is based upon and claims the benefit of priority from prior Japanese Patent Application No. 2009-292911, filed Dec. 24, 2009, the entire contents of which are incorporated herein by reference.

### BACKGROUND OF THE INVENTION

1. Field of the Invention

The present invention relates to screws for use in radio wave receivers, a method of making the screws and radio wave receivers using the screws.

2. Description of the Related Art

At present, radio-controlled watches are widely used because they save you the trouble of setting time. The radio-controlled watches include an antenna such as, for example, a bar antenna which receives a time and frequency signal containing time data or codes, thereby automatically setting time based on the signal received by the antenna.

The antenna is encased within a case of the watch, so that when the case and its back cover are made of a metal, there is a problem that the reception sensitivity of the antenna is reduced. Two probable causes of the problem are given. First, since generally metal has high electrical conductivity, entrance of the radio waves into a space surrounded by the metal is hindered by its electromagnetic wave shielding operation. Second, when an electric current flows in the vicinity of the antenna, an electromagnetic field in the vicinity of the antenna is disturbed, thereby producing noise. As a result, the reception sensitivity is reduced.

These two problems are, of course, avoided by forming the case and the back cover with a non-metal material. However, it is desired in a radio-controlled wristwatch that the case and the back cover be made of metal from the standpoint of a sense of high quality including beauty, texture and weightiness, for example. In addition, there is a high need to thinned and miniaturized radio-controlled wristwatches. In order to satisfy this need, the antenna is required to be thinned, but a reduction in the reception sensitivity should be restrained.

As disclosed in Japanese Patent Application KOKAI Publication No. 2006-112866, a radio-controlled wristwatch is known in which an insulation spacer is provided in a space between the metal case and the metal back cover for receiving a screw which secures the case and back cover together in order to restrain an electric current due to changes in external magnetic flux produced in an antenna disposed within the case from flowing from the case to the back cover or vise versa.

Also, as disclosed in Japanese Patent Application KOKAI Publication No. 2008-82722, a radio-controlled wristwatch is known in which an insulation spacer is provided between the metal case and the metal back cover which are secured together with a conductive screw whose substantially whole surface is covered with an insulation film.

When the both wristwatches of Japanese Patent Application KOKAI Publication Nos. 2006-112866 and 2008-82722 are compared, the latter radio-controlled wristwatch is improved in reception sensitivity of the antenna compared to the former wristwatch. This is because in the latter the substantially whole surface of the screw which secures the metal case and the metal back cover together is covered with the insulation film. Thus, when external radio waves are received, the electric current due to changes in the magnetic flux produced in the antenna disposed within the metal case is more restrained from flowing between the case and the back cover.

When the arrangement of the radio-controlled wristwatch disclosed in Japanese Patent Application KOKAI Publication No. 2008-82722 is employed, the insulation film covering the substantially whole surface of the conductive screw puts the metal case and back cover in an electrically isolated state, thereby improving the reception sensitivity of the antenna. However, a threaded shank of the conductive screw is screwed through the insulation layer formed on a substantially whole surface thereof into a female hole in the metal case. Thus, the insulation film layer is liable to be separated from the shank of the screw, and the screw cannot tighten the case and the back cover together firmly.

Although the problems with the prior art radio-controlled watches have been illustrated as an example, the above problems are not limited to the radio-controlled watches but are common to radio wave receivers which include an antenna within the case. Those problems occur when the case and the back cover are made of metal. Thus, with radio wave receivers with an antenna therein, further improvements in the reception sensitivity of the antenna and strong fixation between the metal case and the metal back cover are desired.

It is therefore an object of the present invention is to provide a screw for use in a radio wave receiver to sufficiently insulate its metal case and metal cover from each other and secure both together firmly, a method of making the screw and a radio wave receiver using the screw.

### BRIEF SUMMARY OF THE INVENTION

In one aspect, the present invention provides a screw for use in a radio wave receiver, comprising: a metal screw body that includes a shank and a head; and an insulation resin layer formed on a back of at least the head.

In another aspect, the present invention provides a radio wave receiver comprising: an antenna for receiving radio waves; a metal case with an open end in which case the antenna is disposed; a metal cover that closes the open end of the case; a screw that secures the cover and the case together, and wherein: the screw comprises a metal screw body that includes a shank and a head, and; and wherein the cover and the case are secured together by the screwed engagement of an insulation resin layer-free threaded portion of the shank in a screw hole formed in the case with the insulation resin layer disposed between the case and the screw head.

In still another aspect, the present invention provides a method of making a screw for use in a radio wave receiver, the screw comprising a metal screw body that includes a shank and a head, and an insulation resin layer formed on at least a back of the head, comprising: (a) in a state where a front side of the head and a part of the shank distal from the head are covered externally, spaying a solution containing an insulation resin against a non-covered part of the screw, thereby forming a resin containing layer on the appropriate part of the screw; and (b) heating the screw body with the resin containing layer formed thereon to form the insulation resin layer on the screw.

Thus, according to the present invention, the metal case which contains the antenna is sufficiently electrically insulated from the metal cover and tightened firmly to same.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1A is a plan view of a screw for use in a radio-controlled watch according to one embodiment of the present invention.

FIG. 1B is a side elevational view of the screw for use in a radio-controlled watch according to one embodiment of the present invention.

FIG. 2 is a cross-sectional view taken along a II-II in FIG. 1B.

FIG. 3 is a partial cross-sectional view of the watch using the screw according to the embodiment.

FIG. 4 is an enlarged view of a part of FIG. 3.

FIG. 5A is an optical image indicative of an appearance of the screw according to the embodiment.

FIG. 5B is an optical image indicative of the appearance of the screw according to the embodiment.

FIG. 6A is a front view of a screw for use in the radio-controlled watch according to another embodiment of the present invention.

FIG. 6B is a side elevational view of the screw for use in the radio-controlled watch according to the other embodiment of the present invention.

FIG. 7 is a cross-sectional view taken along a line VII-VII of FIG. 6B.

FIG. 8A is a cross-sectional view indicative of a method of making a screw for use in the radio-controlled watch according to one embodiment of the present invention.

FIG. 8B is a cross-sectional view indicative of the method of making a screw for use in the radio-controlled watch according to one embodiment of the present invention.

FIG. 8C is a cross-sectional view indicative of the method of making a screw for use in the radio-controlled watch according to one embodiment of the present invention.

FIG. 8D is a cross-sectional view indicative of the method of making a screw for use in the radio-controlled watch according to one embodiment of the present invention.

FIG. 8E is a cross-sectional view indicative of the method of making a screw for use in the radio-controlled watch according to one embodiment of the present invention.

FIG. 9A is a cross-sectional view indicative of a method of making a screw of another embodiment.

FIG. 9B is a cross-sectional view indicative of the method of making a screw of the other embodiment.

FIG. 9C is a cross-sectional view indicative of the method of making a screw of the other embodiment.

FIG. 9D is a cross-sectional view indicative of the method of making a screw of the other embodiment.

FIG. 10 is a side elevational cross section of a screw for use in the radio-controlled watch according to still another embodiment of the present invention.

FIG. 11 is a fragmentary cross-sectional view of the radio-controlled watch in which a first modification of the screw is used.

FIG. 12 is a view similar to FIG. 11 in which a second modification of the screw is used.

### DETAILED DESCRIPTION OF THE INVENTION

Referring to the accompanying drawings, screws for use in the radio-controlled watch according to the embodiments of the present invention and a method of making the screws will be described.

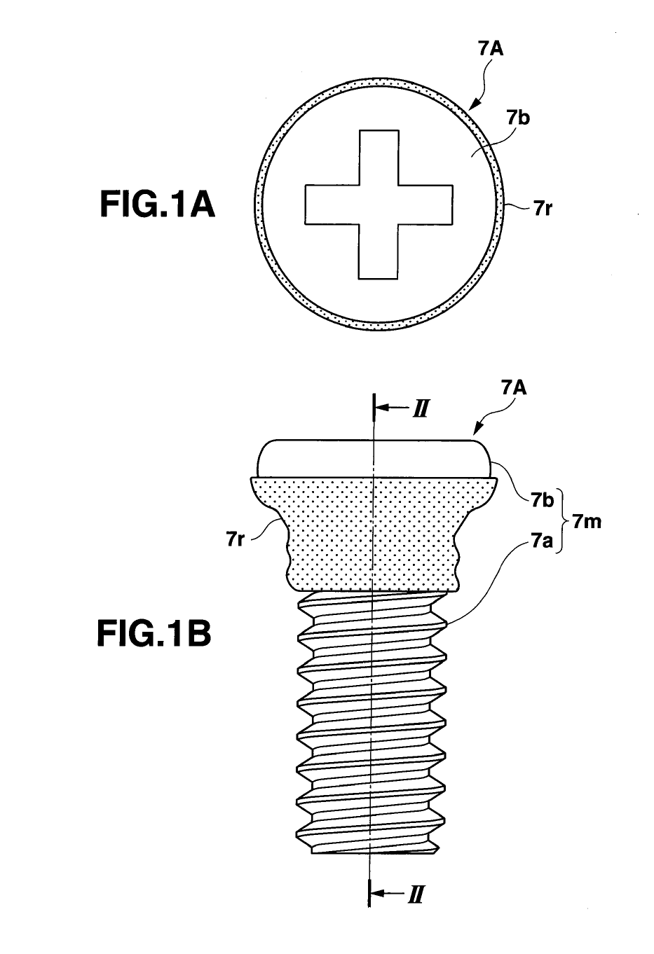

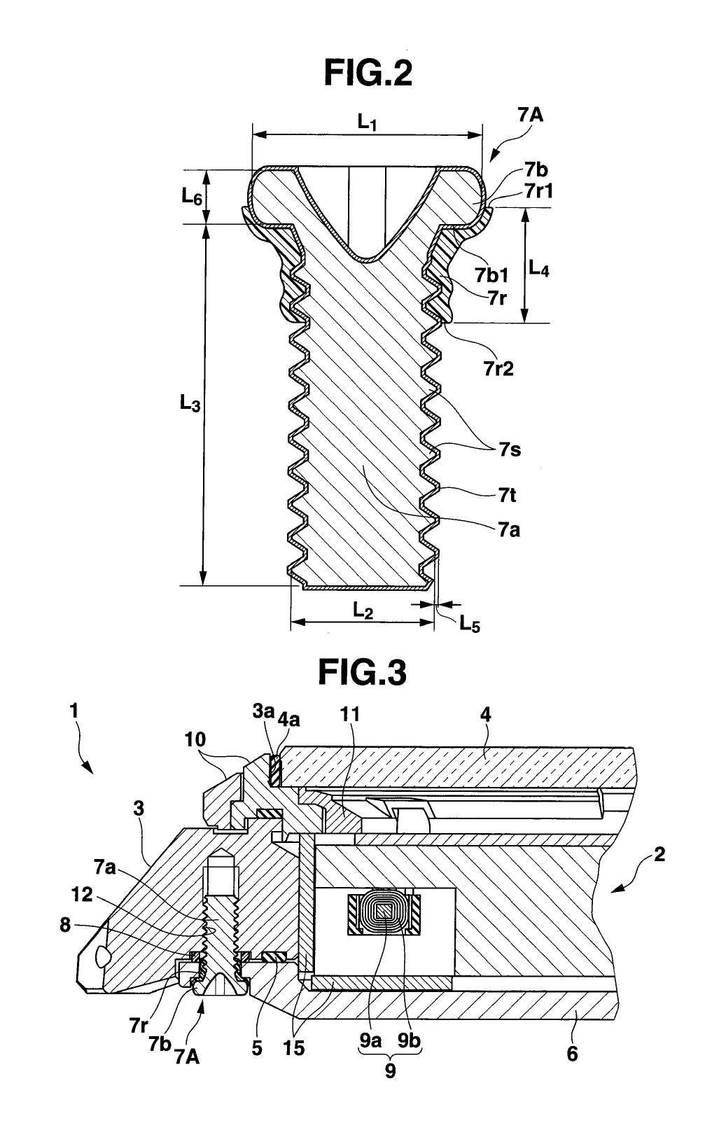

FIGS. 1A, 1B and 2 show the structure of a screw 7A of one embodiment. The screw 7A comprises a metal body 7m that has a shank 7a and a head 7b with an annular insulation layer 7r provided continuously on a back 7b1 of the head and around a part of the shank 7a adjacent to the head 7b. The outer diameter L₁ of the head 7b is larger than the outer diameter L₂ of the shank 7a. The head of the screw 7A can also be referred to as a flange of the screw.

The front of the screw head refers to a surface in which a Phillips slot is formed. The back 7b1 of the screw head 7b refers to its (seating) surface on the side of the shank and the front of the head 7b refers to its surface opposite to the shank side.

As mentioned above, the screw 7A is provided with the annular insulation resin layer 7r thereon which continuously covers the back 7b1 of the head 7b and the part of the shank 7a adjacent to the head 7b. Thus, the screw 7A is provided with the annular insulation resin layer 7r which continuously covers the back 7b1 of the head the annular insulation resin layer 7r covers only a part of a threaded part 7s of the shank 7a adjacent to the head 7b. As will be illustrated later in an experimental example, if the screw, whose whole surface is covered with the insulation layer 7r, is tightened and then loosened, a part or all of the resin layer 7r will be separated from the screw, and its electrical non-conductance will be reduced, which is referred to as “repetition tolerance” in this specification.

From the standpoint of the repetition tolerance, the length L₄ of the threaded shank 7s covered with the insulation film layer 7r is preferably less than 30% of the overall length L₃ of the threaded shank 7s. L₄ and L₃ are selected so as to be at a proper ratio.

The thickness L₅ of the insulation layer 7r is preferably from 30 μm through 100 μm. If it is less than 30 μm, satisfactory electrical non-conductance cannot be obtained whereas if it is thicker than 100 μm, the repetition tolerance of the screw will be reduced. Even the insulation resin layer 7r formed only on the back of the head 7b exhibits satisfactory electrical non-conductance.

The insulation layer 7r is preferably made of a thermosetting resin. To this end, a one- or two-liquid thermosetting resin commercially available as paints for metals may be used. The thermosetting resins are excellent in adhesiveness to metal compared to the thermoplastic resins. Especially, a plastic resin cured at a temperature higher than 40° C. is excellent in mechanical characteristic and thermal resistance. As will be illustrated in an experimental example later, the thermosetting resin is preferably an urethane acrylate resin. The insulation resin layer 7r is preferably colored such that the presence of which can be easily and visually ascertained.

The whole surface of the screw 7A of FIGS. 1 and 2 is covered with a thin insulation film 7t before the screw is partially covered with the insulation resin layer 7r. As described above, the prior art fixing screw disclosed in the Japanese Patent Application KOKAI Publication No. 2008-82722 also has a thin insulation film thereon, but cannot obtain satisfactory electrical non-conductance. Thus, from the standpoint of the electrical non-conductance, the thin insulation film 7t may be omitted. However, the insulation film 7t is preferably provided in order to improve protection of the surface of the screw body 7m, for example, from its oxidization and the ease of insertion of the screw part 7s into a screw hale 12 formed in the bottom of the case 3 which is hereinafter referred to as “slidability” of the screw.

The thin insulation film 7t is made, for example, of a non-organic material or DLC (Diamond Like Carbon) excellent in hardness, lubricity, and wear and abrasion resistance. The non-organic material may include one selected from the group of titanium carbide (TiC), titanium nitride (TiN), titanium oxide (TiOx), silicon nitride (Si₃N₄), and aluminum oxide (Al₂O₃). The film of this selected material may be formed, using a well-known thin film depositing technique such as, for example, ion plating, vacuum evaporation or sputtering. The DLC film is preferably formed in the plasma CVD using a hydrocarbon gas such as acetylene from the standpoint of mass production. The thickness of the insulation resin film 7t is set to an appropriate one by considering a set throughput in a range thereof where the satisfactory slidability of the screw 7 and satisfactory electrical non-conductance between the back cover 6 and the screw 7 are obtained. The DLC film has the advantages of highly improving slidability and bringing about high mass production or low manufacturing cost.

The screw 7A can be used as a preferable one for the wristwatch 1 of FIG. 3, which is a partial cross-sectional view of the wristwatch. As shown in FIG. 3, the wristwatch 1 includes a metal case body 3 open at its both ends and encases a timepiece module 2 therein, a glass cover 4 attached through a gasket 4a to a top end of the case 3, a metal back cover 6 attached through a water-proof gasket 5 to the lower end of the case 3, the screw 7A that secures the back cover 6 and the case body 3 together, and an annular spacer 8 disposed between the case body 3 and the back cover 6.

The timepiece module 2 includes various electronic parts such as a time display and/or an LSI that performs the timepiece function and an antenna 9 that receives a time and frequency signal for automatically setting time based on the time and frequency signal received by the antenna 9. The antenna 9 is in the form, for example, of a bar antenna which includes a magnetic bar-like core 9a of high permeability and low conductivity with a coil 9b of cupper lead wound around the core 9a.

The case 3 is made of a metal of high strength such as stainless steel or titanium. An ornamental bezel 10 is disposed over the case 3. A ring-like delimiting member 11 is disposed below the glass cover 4 coaxially within the case 3. The case 3 has a female screw hole 12 on a lower surface of the case 3 into which the threaded shank 7s of the screw 7A is screwed.

The back cover 6 is in substantially the form of a plate of high strength such as stainless steel or titanium, like the case 3. The back cover 6 has a screw hole 13 therein where a screw 7 is inserted at a position corresponding to that of the screw hole 12.

The spacer 8 is in the form of a ring having a central hole 8a into which the screw 7A is inserted and is made of an insulation material such as plastic resin or ceramic. The spacer 8 is disposed between the case 3 and the back cover 6 to prevent electrical conduction due to contact therebetween.

Parts of the insides of the case 3 and the back cover 6 adjacent to the antenna 9 are covered with a magnetic sheet 15, which prevents eddy currents due to a magnetic field produced by the antenna 9 from occurring in the metal case 3 and the metal back cover 6.

According to this case 1, the spacer 8 is disposed between the back cover 6 and the case 3 which contains the antenna 9. Thus, although the case 3 and the back cover 6 are made of metal, the spacer 8 prevents electrical conduction due to contact between the case 3 and the back cover 6.

Use of the screw 7A of this embodiment as a screw 7 serves to prevent electrical conduction between the case 3 and the back cover 6 through the screw 7A. As will be illustrated later by an experimental example, use of this screw brings about a resistance of more than 10 MΩ between the case body 3 and the back cover 6, as measured by a tester, high repetition tolerance and high reliability.

As shown in FIG. 3, the wristwatch 1 of this embodiment comprises the radio reception antenna 9, the metal case 3 within which the antenna 9 is disposed, the metal back cover 6 which closes the open end 3a of the metal case 3, and the screw 7a that secures the back cover 6 and the case 3 together.

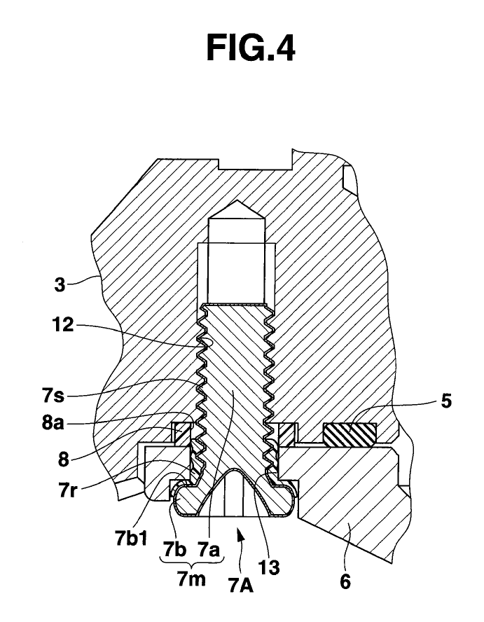

The screw 7A includes the metal body 7m that includes the shank 7a and the head 7b, and the insulation resin layer 7r that covers only the back 7b1 of the head 7b or otherwise the back 7b1 of the head and the part of the shank 7a adjacent to the back 7b1 of the head 7b. As shown enlarged in FIG. 4, the metal back cover 6 and the metal case 3 are tightened together by the screw 7 whose threaded portion 7s of the shank 7a, where no insulation resin layer 7r is formed, is engaged in the screw hole 12 in the case 3 with the insulation resin layer 7r disposed between the back cover 6 and the screw 7A.

According to the arrangement of this wristwatch 1, the metal back cover 6 and the metal case 3 are tightened together by the screw 7 whose threaded portion 7s of the shank 7a, where no insulation resin layer 7r is formed, is engaged in the screw hole 12 in the case 3 with the insulation resin layer 7r disposed between the back cover 6 and the screw 7A. Further, the insulation spacer 8 is disposed between the back cover 6 and the screw 7A. In addition, the insulation resin layer 7r is formed continuously on the back of the screw head 7b and around the part of the shank adjacent to the head 7b.

Thus, in reception of external radio waves, a flow of an electric current between the metal case 3 and the metal back cover 6 due to changes in the magnetic flux produced in the antenna 9 disposed within the metal case 3 is much more restrained, thereby improving the reception sensitivity of the antenna 9, and achieving high electric isolation between the metal case 3 and the metal back cover 6.

In addition, because of the threaded engagement of the threaded part 7s of the shank 7a, on which no insulation resin layer is formed, in the screw hole 12 in the case 3, the repetition tolerance of the screw 7 is not lowered, and in the metal case 3, the case 3 and the back cover 6 are secured together firmly.

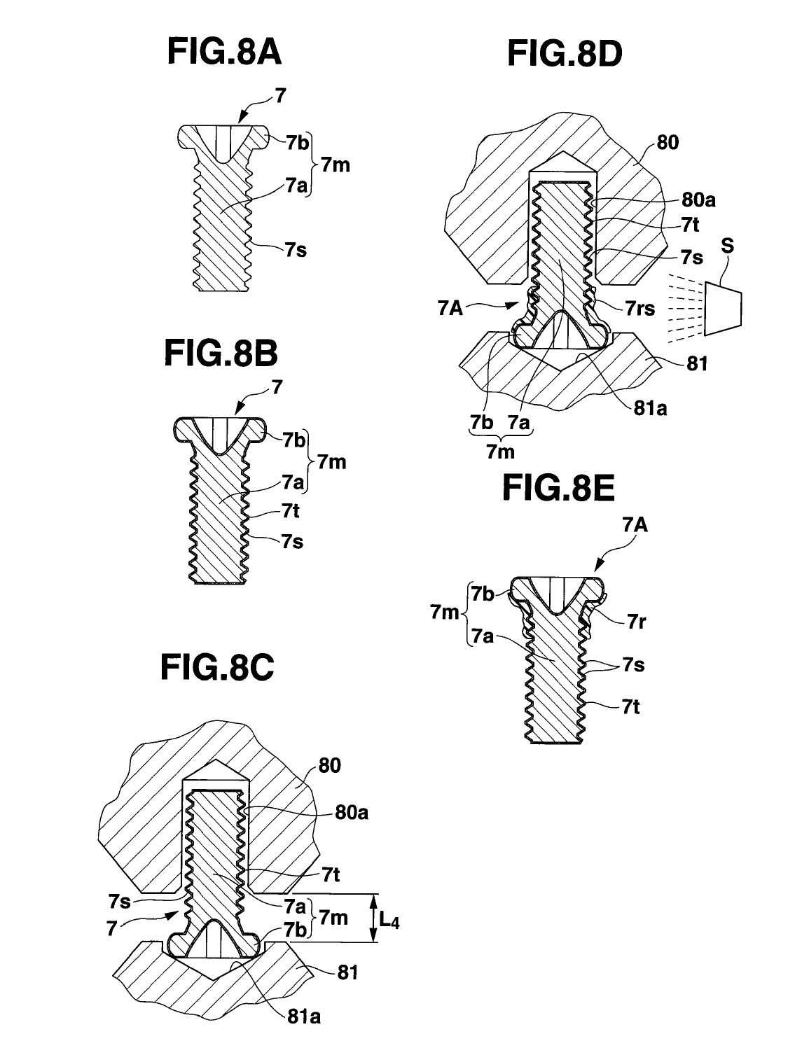

Referring to FIGS. 8A-8E, a method of making the screw 7A according to the present invention will be described. This method comprises the steps of preparing a screw 7 with a screw body 7m (FIG. 8A), forming a thin insulation film 7t on a whole surface of the screw body 7m (FIG. 8B), and covering the front side of the screw head 7b and a part of the threaded portion 7s of the shank, excluding the part of the shank adjacent to the head back, with first and second blocks 80 and 81 so as to receive the front side of the screw head 7b and the part of the threaded portion 7s of the shank except for the part of the shank adjacent to the head back in the recesses 80a and 81a in the blocks 80 and 81, respectively (FIG. 8C). The method further comprises spraying a solution containing an insulation resin such as, for example, a liquid thermosetting plastic resin against the exposed part of the screw 7 (including the back of the screw head and the part of the shank adjacent to the head back) from both its sides to form a resin containing layer 7rs in position on the screw, using spraying devices S in a spray-coating process (FIG. 8D, which omits depiction of the left-hand spraying device S), and then heating the screw body 7m with the resin containing layer 7rs deposited therearound (FIG. 8E), thereby producing the screw 7A with the insulation resin layer 7r.

When a thermosetting resin is contained as the insulation resin in the solution, the solvent contained in the solution deposited on the screw is removed in the heating process, the screw is dried, the thermosetting reaction proceeds and the insulation resin layer 7r is formed on the screw. The heating process may be performed in a multi-stage manner. Also, when a thermoplastic resin is used as the insulation resin, the insulation resin layer 7r is likewise obtained. A mixture of a thermosetting plastic resin and a thermoplastic resin may be used to form an insulation resin layer.

Although the insulation resin layer 7r may be formed only on the back 7b1 of the screw head 7b, it is preferably formed over a length of the screw shank from the back of the screw head to its part adjacent to the head back from the standpoint of workability, yield of materials and electrical non-conductance.

Although formation of the thin insulation film 7t over the whole surface of the screw body 7m has been illustrated before the insulation resin layer 7r was formed, the screws of the present invention are not limited to only these illustrated ones. For example, the slidability of the screw is improved by forming an insulation film 7t on at least the surface of the threaded part 7s where no insulation resin film 7r is formed. From the standpoint of protection of the surface of the screw body 7m, the thin insulation film 7t is preferably formed over the whole surface of the screw body 7m.

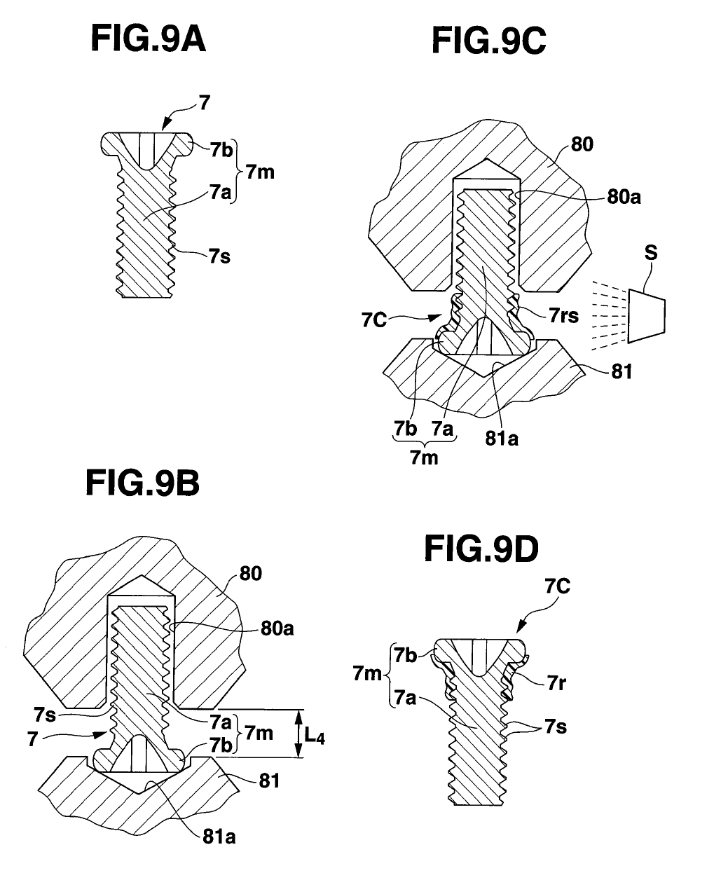

As described above, the step of forming the thin insulation film 7t may be omitted. A method of making a screw for use in the radio-controlled watch where the formation of the insulation film 7t is omitted will be described later with reference to FIG. 9.

In the step of FIG. 8C, the first and second blocks 80 and 81 are required to be disposed spaced by a distance equal to the length L₄ of the insulation resin layer 7r formed on the shank.

The screw with the insulation layer thereon may be formed in a dipping process, but in the spray-coating process, the insulation film layer 7r can be efficiently formed only on the back 7b1 of the screw head 7b or continuously on the head back 7b1 and a part of the shank 7a adjacent to the screw head 7b. Further, the thickness control of the insulation resin film 7r is easily performed in the spray-coating process compared to in the dipping process. Especially, an insulation film layer 7r of from 30 μm-100 μm is easy to form selectively.

Before spraying the insulation resin solution, a grease removing process for the screw body 7m (for example, in an alkali process) and/or a primer process may be performed as required. Epoxy resin or polyurethane resin may be used as a primer, for example.

Preferably, the thermosetting resin is used as a material forming the insulation resin layer 7r. In order to cure the insulation resin layer 7r, the process preferably includes heating the insulation film layer 7r at a first temperature of 100° C. or more. As will be illustrated in the experimental examples, the thermosetting resin is, for example, an urethane acrylate resin and its first temperature is preferably in the range of from 140 to 200° C., and more preferably at 160° C., from a standpoint of hardening and decomposition of the resin. An appropriate heating time is set as required. The resin may be heated in a multi-stage manner. When set at a temperature of 140° C. or higher, the resin is excellent in mechanical characteristic and heat resistance. Use of a resin that requires heating at 200° C. or higher would reduce a throughput undesirably. Although a resin curable at room temperature may be used, its workability can be reduced because, for example, the pot life of the resin is short.

In the spray coating process, a resin layer having a uniform thickness of 30 μm or more is difficult to form in a single spraying step. Thus, it is preferable to perform two or more spraying steps, and between each spraying step, a temporary drying process that heats a resulting resin layer at a second temperature lower than the first temperature for setting purpose. The second temperature is preferably less than 100° C. and is, for example, 60° C. When the second temperature is 100° C. or higher, the curing of the thermosetting resin proceeds, thereby reducing adhesiveness between a resulting resin layer and the screw. After the last spraying process, the screw may be subjected to a thermosetting process without resorting to the temporary drying process or to the thermosetting process after the temporary drying process.

The embodiment of the present invention will be described in greater detail by indicating the experimental examples. In the experimental examples, screws were made in the method illustrated with reference to FIGS. 8A-8E. Each screw body 7m had the shape shown in FIGS. 1 and 2. The outer diameter L₁ of the screw head 7b was 2.5 mm, the thickness L₆ of the head 7b was 0.6 mm, the outer diameter L₂ of the shank 7a or the threaded part 7s was 1.6 mm, and the length L₃ of the screw was 4.4 mm.

A thin titanium carbide (TiC) film 7t was formed on the whole surface of each screw body 7m in an ion plating process. The thickness of the titanium carbide film 7t was approximately 1 μm. Since the surface of the screw 7m had a complicated shape, the thickness of the titanium carbide film 7t was uneven and its range was approximately 0.5 μm-1.5 μm.

Then, insulation resin layers 7r having a thickness of 10 μm-70 μm and of various resin materials (poly-para-xylene, epoxysilicon, epoxyacryl, modified polyester, silicon acrylate, polyimide urethane, mixtures of fluoropolyol and polyimide, and urethane acrylate) were formed around the respective whole surfaces of half of the screws. Likewise, the same resin layers were formed around the backs 7b1 of the screw heads 7b and parts of their shanks 7a (30% of their length) adjacent to the screw heads of the other half of the screws. Among the resins illustrated herein, the poly-para-xylene was a thermoplastic resin and the others were a thermosetting resin.

In order to form the insulation resin layers 7r, the spray coating process was employed because the thickness of the layers 7r was easy to control and insulation resin layers 30 μm-100 μm thick were easy to form selectively compared to the evaporation method (poly-para-xylene) and the dipping method. Since the electrical non-conductance of some screws with a thickness of less than 30 μm was not satisfactory, insulation layers 7r having a thickness of 30 μm or more were employed.

The head 7b and a part of the shank 7a excluding its part adjacent to the head 7b were received within the recesses 80a and 81a formed in the two blocks 80 and 81, respectively. Then, an insulation resin solution was sprayed a required number of times against a non-covered or exposed part of the screw from both its sides using the spraying devices S. A first spraying step brought about an insulation layer 7r approximately 30 μm thick in position on the screw. In order to obtain an insulation layer 30 μm or more thick in position on the screw, two or more spraying steps were required and a temporary drying step was performed between each spraying step. For example, in the case of urethane acrylate, a first spraying step was performed using a solution of the resin on a screw, and then a temporary drying step was performed at 60° C. for 10 minutes. Then, a second spray-coating step was performed using the same solution and the heating step was performed between each spraying step at 160° C. for 60 minutes for curing purpose. In the case of the mixtures of fluoropolyol and polyimide, the heating step was performed at 230° C. for 30 minutes for final curing purpose.

Electrical non-conductance of sample screws whose whole bodies were covered with only a thin titanium carbide film 7t, sample screws whose whole surfaces were covered with an insulation resin layer 7r and sample screws whose partial surfaces were covered with the insulation resin layer 7r (the screws 7A of FIGS. 1A, 1B and 2) were evaluated when the cases and the back covers were tightened together with those sample screws. For tightening purpose, an electrical driver was used which was set to 1.5 kgf·cm by a torque meter. The electrical non-conductance of the respective screws was evaluated by a tester. Wristwatches having a resistance of 10 MΩ or more were evaluated as meeting inspection standards. It was ascertained that the reception sensibility of the watches which passed this test was high by 0.5-1.3 dB compared to the watches using sample screws with a thin titanium oxide thereon (where the electrical non-conductance of the watches was approximately 0Ω). For inspecting the repetition tolerance, tightening and loosening the screws were repeated, and then it was visually checked whether the insulation resin layers were separated from the screws and whether resin powder was produced. Then, the electrical non-conductance was checked. Although for the repetition tolerance the screws which withstood 5 repetitions of tightening and loosing thereof were considered as meeting mass production standards, screws which withstood up to 10 repetitions of tightening and loosing thereof were sought.

It was observed that the layers of all the respective kinds of insulation resin materials formed on the whole surfaces of the screws were separated from the screw bodies during 10 repetitions of their tightening and loosing operations. It is noted that sample screws whose whole surfaces were covered with urethane acrylate were broken at a first tightening step.

Sample screws on which the respective insulation resin films 7r were formed partially were improved in repetition tolerance compared to the sample screws whose whole surfaces were covered with the respective insulation resin layers. However, the sample screws which passed 10 or more repetition tolerance tests were only the ones covered with urethane acrylate and the ones covered with the mixture of fluoropolyol and polyimide (having a thickness of 50 μm). Urethane acrylate withstood 10 or more repetition tolerance tests even after left in a high temperature state of 175° C. for 24 hours and after immersed in water at room temperature for 168 hours. Thus, this material was determined as optimal to be used as the insulation resin. Analysis of this urethan acrylate using FT-IR [(FTIR-8300, reflection type beam condenser (RBC-8000) manufactured by Shimazu Seisakusyo, KBr pellet method)] indicated that a spectrum coinciding substantially with Sadtler library HP (HUMMEL Polymer) # 2220 was obtained.

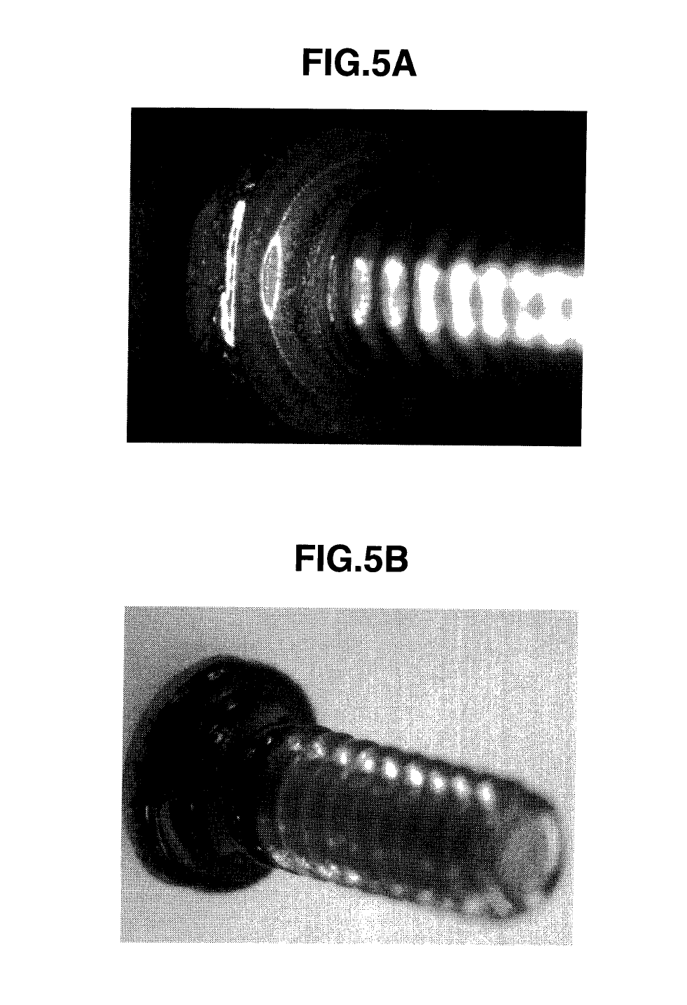

FIG. 5A shows an optical image of the back of the head of a screw with a transparent urethan acrylate resin layer on the head back. FIG. 5B shows an optical image of a screw with a black urethan acrylate resin layer thereon. These screws exhibited similar excellent results. As will be seen from FIGS. 5A and 5B, the resin layer is formed selectively and evenly on the back of each screw head and the part of its shank adjacent to the head back.

Although the urethan acrylate is illustrated as the optimal thermosetting resin herein, the resin material of the screws of FIGS. 1 and 2 may be replaced with another resin to improve the electrical non-conductance compared to the prior art screws.

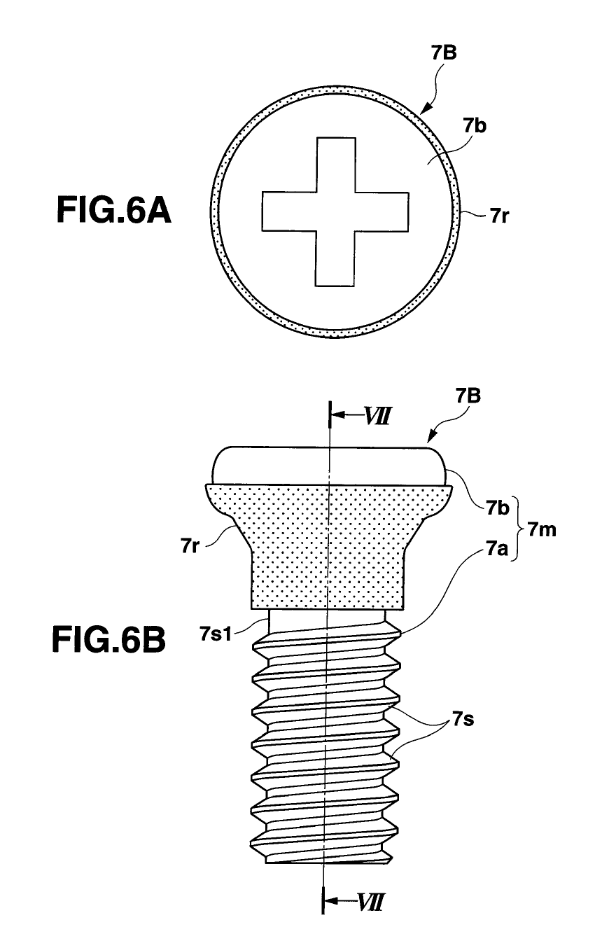

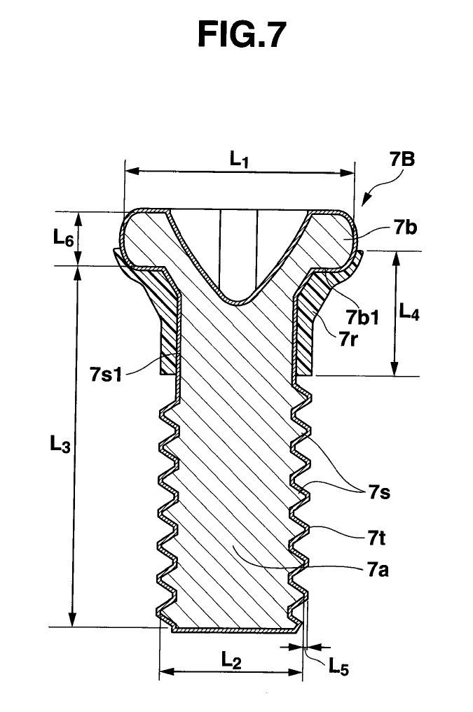

FIGS. 6 and 7 are a cross-sectional view of a screw of another embodiment. Like the screw 7A of FIGS. 1A, 1B and 2, the screw 7B of FIGS. 6A, 6B and 7 comprises a screw body 7m of a metal shank 7a and a metal head 7b, and an insulation resin layer 7r formed on the back 7b1 of the screw head 7b and a part of the shank 7a adjacent to the head back.

The whole shank 7a of the screw 7A of FIGS. 1A, 1B and 2 has male threads 7s formed thereon whereas the shank 7a of the screw 7B of FIGS. 6A. 6B and 7 has a non-threaded shank part 7s1 adjacent to the head back of the screws. The insulation resin layer 7r of FIGS. 6A, 6B and 7 is illustrated as formed only on the head back 7b1 and the part of the shank adjacent to the head back, but may be formed in a different manner.

Like the screw 7A of FIGS. 1A, 1B and 7, the screw 7B of this embodiment comprises a metal screw body 7m, which in turn includes the shank 7a and the head 7b, and the insulation resin layer 7r covering only the back of the screw head 7b or continuously covering the back 7b1 of the screw head 7b and the part of the shank 7a adjacent to the had back. The metal back cover 6 and the metal case 3 are tightened together by the engagement of the insulation layer-free threaded part 7s of the shank of the screw 7B in the threaded hole 12 formed in the metal case 3 with the insulation resin layer 7r disposed between the screw 7B and the back cover 6. Thus, the back cover 6 and the case body 3 are electrically isolated satisfactorily by the insulation resin layer 7r. In addition, the back cover 6 and the case 3 are tightened together firmly by the engagement of the insulation layer-free threaded part 7s of the screw shank in the threaded hole 12 in the case 3.

Referring to FIGS. 9A-9D, a method of making a screw 7C for use in the radio-controlled watch according to another embodiment of the present invention will be described. As shown in FIG. 9A, this method comprises the steps of preparing a screw 7 having a body 7m (similar to the step of FIG. 8A), and covering the front side of the screw head 7b and a part of a threaded portion 7s of the screw opposite to the screw head 7b, with first and second blocks 80 and 81, respectively (FIG. 9B) by omitting the step of forming an insulation film 7t on the whole surface of the screw body 7m such as shown in FIG. 8.

The process further includes a step of spraying an insulation resin solution against the back of the screw head and the part of the shank adjacent to the head back to form a soft resin-containing layer 7rs in position (FIG. 9C), and then heating the screw body 7m with the resin containing layer 7rs formed on the screw body (FIG. 9D), thereby providing the screw 7C with the insulation resin layer 7r formed thereon.

According to this screw making method, the insulation resin layer 7r is directly formed only on the back surface of the screw head and the part of the shank adjacent to the screw head without forming the thin insulation film on the screw beforehand. Thus, inexpensive screws for use in the radio-controlled wristwatch are manufactured rapidly.

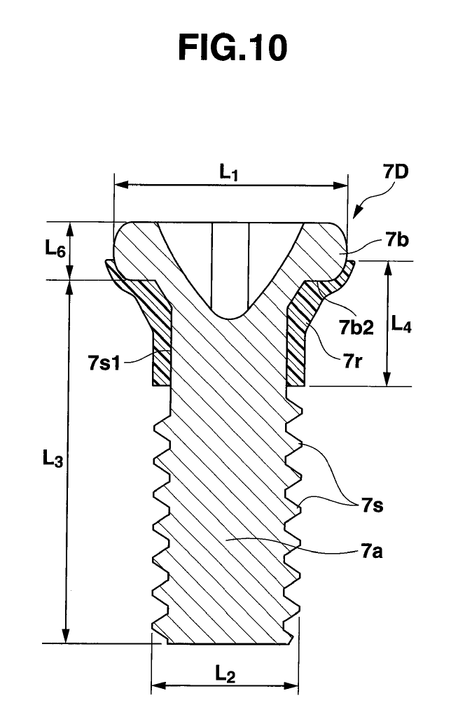

Like the screw 7B of FIGS. 6A, 6B and 7, a screw 7D of FIG. 10 comprises a screw body 7m of a metal shank 7a and a metal head 7b, and an insulation resin layer 7r formed on the back 7b1 of the screw head 7b and a part of the shank 7a adjacent to the head back. The screw 7B of FIGS. 6A, 6B and 7 has external threads 7s formed over its length around its outer circumference whereas the screw 7D of FIG. 10 has a non-threaded shank part 7s1 adjacent to the head back thereof.

Like the screw 7B of FIGS. 6 and 7, the screw 7D of FIG. 10 comprises the screw body 7m of a metal shank 7a and the metal head 7b, and the insulation resin layer 7r formed on the back 7b1 of the screw head 7b and the part of the shank 7a adjacent to the head back. The metal back cover 6 and the metal case 3 are electrically isolated satisfactorily by the insulation resin layer 7r provided between the cover 6 and the case 3 as well as tightened together firmly by the screwed engagement of the insulation resin layer-free threaded part 7s of the screw shank 7a in the screw hole 12 formed in the metal case 3.

With the screws 7A-7D of these embodiments, although the insulation resin layer 7r is illustrated as formed also on the part of the shank 7a, it may be formed only on the back surface of the screw head 7b.

With the embodiments of FIGS. 2, 7, 8A-8E and 9A-9D, the insulation resin layer 7r is illustrated as formed on the back surface of the screw head 7b, the part of the side of the screw head 7b and the part of the side of the shank 7a adjacent to the back head. That is, as shown best in FIG. 2, one or upper end 7r1 of the insulation film layer 7r is somewhat below the position of the maximum outer diameter of the head and the other or lower end of the insulation film layer 7r is at a position shown by 7r2 on the shank somewhat below the back surface of the screw head 7b.

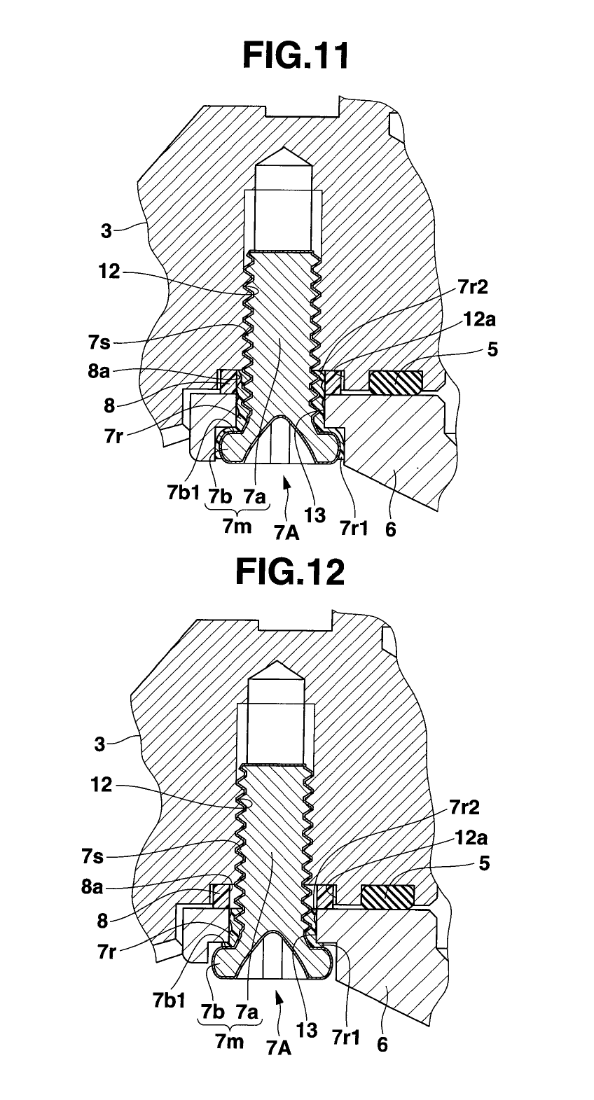

However, the range of formation of the insulation resin layer 7r is not limited to only such illustrated ones. For example, FIG. 11 shows a first modification of the insulation resin layer 7r. With a screw 7A involving this modification, one or lower end 7r1 of the insulation resin layer 7r is close to the front of the screw head 7b whereas the other or upper end 7r2 of the insulation resin layer 7r is at the position of the bottom of a hole 12a provided on the lower end of the case 3 larger than the screw hole 12 provided also on the lower end of the case 3 coaxially with the hole 12a.

When the metal back cover 6 and the metal case 3 aligning with the back cover 6 are tightened by the screw 7A by causing the insulation resin layer-free threaded part 7s of the screw shank 7a to be screwed into the screwed hole 12 in the case 3, the back cover 6 and the case 3 are tightened together firmly because no insulation resin layer is disposed between the case 3 and the back cover 6. In addition, the insulation resin layer 7r has its end 7r1 at the position close to the front of the screw head 7b and its other end 7r2 at the position of the bottom of the larger hole 12a formed in the case 3. Thus, existence of the insulation resin layer 7r prevents the surface of the screw body 7m from contacting the screw hole 13 and the larger diameter hole 12a formed in the metal back cover 6, thereby avoiding electrical conduction therebetween.

FIG. 12 shows a second modification of the shape of the insulation resin layer 7r. With the screw 7A of this modification, one or lower end 7r1 of the insulation resin layer 7r is close to the back of the screw head 7b whereas the other or upper end 7r2 of the insulation resin layer 7r is at the position of the upper end of the screw hole 12 provided in the case 3.

The metal back cover 6 and the metal case 3 aligning with the back cover 6 are tightened together firmly by the screw 7A because the insulation resin layer-free threaded part 7s of the screw shank 7a is screwed into the screwed hole 12 in the case 3 with no insulation resin layer disposed between the case 3 and the back cover 6. In addition, the insulation resin layer 7r has its one end 7r1 at the position close to the front of the screw head 7b and its other end 7r2 at the position of the upper end of the larger hole 13 formed in the case 3. Thus, like the screw 7A of FIG. 12, the insulation resin layer 7r prevents the screw body 7m from contacting the screw hole 13 formed in the metal back cover 6, thereby avoiding electrical conduction therebetween.

Although these embodiments illustrate the screws for use in the radio-controlled watches and the radio-controlled watches including such screws, the present invention is applicable to various other screws for use in various radio wave receivers such as, for example, mobile phones and GPS receivers, and other radio receivers using these screws.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A screw for use in a radio wave receiver, comprising: a metal screw body that includes a shank and a had; and an insulation resin layer formed on a back of at least the head.

2. The screw of claim 1, wherein the insulation resin layer is formed only on the back of the head or continuously on the back of the head and a part of the shank adjacent to the back of the head.

3. The screw of claim 1, wherein the insulation resin layer is 30 μm through 100 μm thick.

4. The screw of claim 1, wherein the insulation resin layer is made of a thermosetting plastic resin.

5. The screw of claim 4, wherein the thermosetting plastic resin includes an acrylic urethane resin.

6. The screw of claim 1, wherein the insulation resin layer is colored.

7. The screw of claim 1, further comprising a thin insulation film covering the surface of at least the shank of the screw body.

8. The screw of claim 6, wherein the insulation film covers the whole surface of the screw body.

9. The screw of claim 6 or 7, wherein the thin insulation film is made of a non-organic material or DLC.

10. A radio wave receiver comprising:
an antenna for receiving radio waves;
a metal case with an open end in which case the antenna is disposed;
a metal cover that closes the open end of the case;
a screw that secures the cover and the case together, and wherein:
the screw comprises a metal screw body that includes a shank and a head, and an insulation resin layer formed on a back of at least the screw head; and wherein the cover and the case are secured together by the screwed engagement of an insulation resin layer-free threaded portion of the shank in a screw hole formed in the case with the insulation resin layer disposed between the case and the screw head.

11. The radio wave receiver of claim 10, wherein the insulation resin layer is formed only on the back of the screw head, and wherein the cover and the case are secured together by the screwed engagement of a threaded portion of the shank in a screw hole formed in the case with the insulation resin layer disposed between the case and the screw head.

12. The radio wave receiver of claim 10, wherein the insulation resin layer is formed so as to continuously cover the back of the head and a part of the shank adjacent to the back of the head, and wherein the cover and the case are secured together by the screwed engagement of the insulation resin layer-free threaded portion of the shank in a screw hole formed in the case with the insulation resin layer disposed between the case and the screw head.

13. A method of making a screw for use in a radio wave receiver, the screw comprising a metal screw body that includes a shank and a head, and an insulation resin layer formed on at least a back of the head, comprising:
(a) in a state where a front side of the head and a part of the shank distal from the head are covered externally, spaying a solution containing an insulation resin against a non-covered part of the screw, thereby forming a resin containing layer on the appropriate part of the screw; and
(b) heating the screw body with the resin containing layer formed thereon to form the insulation resin layer on the screw.

14. The method of claim 13, further comprising forming a thin insulation film on the whole surface of the screw before the a) spraying a solution.

15. The method of claim 13, wherein the insulation resin comprises a thermosetting resin; wherein the a) spraying a solution comprises spraying a solution including the thermosetting resin; and wherein the b) heating the screw body is performed at a first temperature of 100° C. or higher.

16. The method of claim 13, wherein: the a) spraying a solution comprises a plurality of steps of spraying a solution, and wherein the b) heating the screw body is performed at a second temperature lower than the first temperature to cure the insulation resin layer between each of the plurality of steps of spraying the solution.
